(19) United States
(12) Patent Application Publication
(10) Pub. No.: US 2026/0110625 A1
(43) Pub. Date: Apr. 23, 2026

(54) RAPID ELLIPSOMETRY USING ENCODED ANGULAR DISTRIBUTION OF LIGHT

(71) Applicant: Onto Innovation Inc., Wilmington, MA (US)

(72) Inventors: Matthew SARTIN, Budd Lake, NJ (US); Alex RUDER, Budd Lake, NJ (US)

(73) Assignee: Onto Innovation Inc., Wilmington, MA (US)

(21) Appl. No.: 18/921,251

(22) Filed: Oct. 21, 2024

(51) Int. Cl. G01N 21/21; G01N 21/01; G02B 3/00; G02B 26/08; G02B 27/28

(52) U.S. Cl. CPC G01N 21/211; G01N 21/01; G02B 3/00; G02B 26/0833; G02B 27/28; G01N 2021/0125; G01N 2021/214; G02B 2003/0093

(57) ABSTRACT

Variable-angle ellipsometry is performed using a high speed polarization state modulator, a photodetector, and a digital micromirror device or spinning disk to encode the angle of incidence of light with a high sampling rate in a time domain or frequency domain. A variable-angle ellipsometer uses a high speed, axially stationary polarization state modulator, such as a photoelastic modulator, and a high speed detector, such as a photodiode, for high speed data acquisition. To acquire data at a plurality of incident angles, a lens is used to generate a large incident angle distribution along an optical axis that is at an oblique angle of incidence and discrete or combinations of incident angles of light are selected in a sequence in the time domain or modulated over a plurality of incident angles in the frequency domain.

### FIELD OF THE DISCLOSURE

The subject matter described herein is related generally to optical metrology, and more particularly to systems and processes for performing ellipsometry.

### BACKGROUND

Semiconductor and other similar industries often use metrology equipment, such as optical metrology equipment, to provide non-contact evaluation of samples during processing. With optical metrology, a sample under test is illuminated with light, e.g., at a single wavelength or multiple wavelengths. After interacting with the sample, the resulting light is detected and analyzed to determine one or more characteristics of the sample.

Ellipsometry is one type of optical metrology in which light with a known polarization state is incident on and reflected from a sample, and the polarization state of the reflected light is analyzed to quantify the change in polarization state produced by the sample. The ellipsometry measurements are typically acquired at multiple polarization states. Additionally, it is sometimes desirable to acquire ellipsometry measurements at multiple incident angles. Acquiring data at multiple polarization states and multiple incident angles typically requires physically moving one or more components in the metrology device, which increases vibrations and reduces throughput.

### SUMMARY

Variable-angle ellipsometry is performed using a high speed polarization state modulator, a photodetector, and a digital micromirror device or spinning disk to encode the angle of incidence of light with a high sampling rate in a time domain or frequency domain. The variable-angle ellipsometer may use a polarization state modulator, such as a photoelastic modulator, and a high speed detector, such as a photodiode, for high speed data acquisition. A lens is used to generate a large incident angle distribution along an optical axis that is at an oblique angle of incidence. To acquire data at a plurality of incident angles in the time domain, mirror elements of the digital micromirror device or holes and/or reflective elements of a spinning disk may be controlled to select a sequence of discrete incident angles of light or to produce a sequence of combinations of incident angles of light. To acquire data at a plurality of incident angles in the frequency domain, mirror elements of the digital micromirror device or holes and/or reflective elements of a spinning disk may be controlled to modulate discrete incident angles of light at different frequencies and the light detected by the photodetector may be demodulated to recover the incident angles of light.

In one implementation, method for performing variable angle ellipsometry includes generating light from a light source and encoding an incident angle distribution of the light. The light is polarized with a polarization state generator, and the light is focused on the sample with an objective lens with the incident angle distribution along an optical axis that is at an oblique angle of incidence. The reflected light from the sample is analyzed with a polarization state analyzer. At least one of the polarization state generator and polarization state analyzer include a polarization state modulator to vary a polarization state of the light. The reflected light is detected with a photodetector having a pixel that detects both the encoded incident angle distribution of the light and varying polarization states of the light produced by the polarization state modulator.

In one implementation, a metrology device is configured for variable angle ellipsometry and includes a light source that generates light and a means for encoding an incident angle distribution of the light. The metrology device further includes a polarization state generator that polarizes the light. An objective lens focuses the light on a sample with the incident angle distribution along an optical axis that is at an oblique angle of incidence. The metrology further includes a polarization state analyzer that analyzes reflected light from the sample. At least one of the polarization state generator and polarization state analyzer include a polarization state modulator to vary the polarization state of the light. A photodetector having a pixel is configured to receive the reflected light and detect both the encoded incident angle distribution of the light and varying polarization states of the light produced by the polarization state modulator.

### BRIEF DESCRIPTION OF THE DRAWINGS

FIG. 1 illustrates a schematic view of a metrology device that may an ellipsometer configured for rapid data acquisition at variable angles of incidence, as described herein.

FIG. 2 is a side view of a portion of conventional variable-angle ellipsometer.

FIG. 3 is a side view of a portion of a variable-angle ellipsometer configured for high speed data acquisition using a polarization state modulator, a photodetector, and a digital micromirror device or rotating disk to encode the angle of incidence of light with a high sampling rate in the time domain.

FIGS. 4A-4D illustrate a sequential angle-scanning sequence and the translation of active and inactive mirror elements of the digital micromirror device into discrete incident angles that may be used to encode the angle of incidence of light in the time domain.

FIGS. 5A and 5B illustrate examples of rotating disks that may perform, respectively, a sequential and continuous angle-scanning sequence with discrete incident angles, similar to that shown in FIGS. 4A-4D.

FIGS. 6A-6D illustrate an angle-scanning sequence and the translation of active and inactive mirror elements of the digital micromirror device into combinations of incident angles that may be used to encode the angle of incidence of light in the time domain.

FIGS. 7A and 7B illustrate examples of rotating disks that may perform, respectively, a sequential and continuous angle-scanning sequence with discrete incident angles, similar to that shown in FIGS. 4A-4D.

FIG. 8 is a side view of a portion of the variable-angle ellipsometer configured for high speed data acquisition using a polarization state modulator, a photodetector, and a digital micromirror device or rotating disk to encode the angle of incidence of light with a high sampling rate in the frequency domain.

FIG. 9 shows an illustrative flowchart depicting an example method for performing variable angle ellipsometry, according to some implementations.

### DETAILED DESCRIPTION

During fabrication of semiconductor devices and similar devices it is often necessary to monitor the fabrication process by non-destructively measuring the devices. Optical metrology techniques, such as ellipsometry, are employed for non-contact evaluation of samples during processing.

As discussed herein, ellipsometry may be performed with a high speed polarization state modulator, a photodetector, and a digital micromirror device (DMD) or rotating disk to encode the angle of incidence of light with a high sampling rate in a time domain or frequency domain for rapid data acquisition. The use of a high speed polarization state modulator, such as a photoelastic modulator (PEM), an acousto-optic modulator (AOM), or an electro-optic modulator (EOM), may be used to enable rapid data acquisition. To acquire data at multiple angles of incidence at comparable speeds, however, requires improvements over conventional variable-angle ellipsometry. For example, conventional variable-angle ellipsometers vary the incident angle of the incident light by physically adjusting the orientations of the delivery and receiving arms of the ellipsometer, e.g., using a goniometer. Alternatively, conventional variable-angle ellipsometers may use large detector arrays that receive different incident angles at different locations on the array. Detector arrays, however, are relatively slow and reduce the benefits of the use of high speed polarization state modulators, such PEMs, AOMs, or EOMs.

Accordingly, as discussed herein, a DMD or rotating disk is used on the delivery side or the receiving side of an ellipsometer to control the incident angles of light, and a lens used to focus light onto the sample over a wide distribution of incidence angles. The reflective mirror elements of the DMD, for example, may be controlled to reflect light at selected offsets from the optical axis to produce or receive light at a plurality of incident angles. A rotating disk may include holes and/or reflective elements and may be controlled to rotate reflect (or transmit) light at selected offsets from the optical axis to produce or receive light at a plurality of incident angles. A high speed polarization state modulator, having a frequency that in some implementations may be greater than the frequency of the DMD or the rotating disk, may be used for modulating the polarization state in the ellipsometer. In some implementations, a rotating compensator may be used as the polarization state modulator. The reflected light may be detected with a photodetector having a pixel that detects both the encoded incident angle distribution of the light and varying polarization states of the light produced by the polarization state modulator. The photodetector, for example, may be a high speed detector having a single pixel detector or other detector having a sampling rate that is greater than the frequency of the polarization state modulator and the frequency of the DMD or rotating disk. Thus, the ellipsometer avoids the need to physically adjust the orientations of the delivery and receiving arms or the use of a large, relatively slow detector array to acquire ellipsometry measurements at each of a plurality of different incident angles. The DMD or rotating disk pattern sampling rates may be comparable to the speed of a PEM or other high speed polarization state modulator, and accordingly, full measurements may be rapidly acquired with high angular resolution.

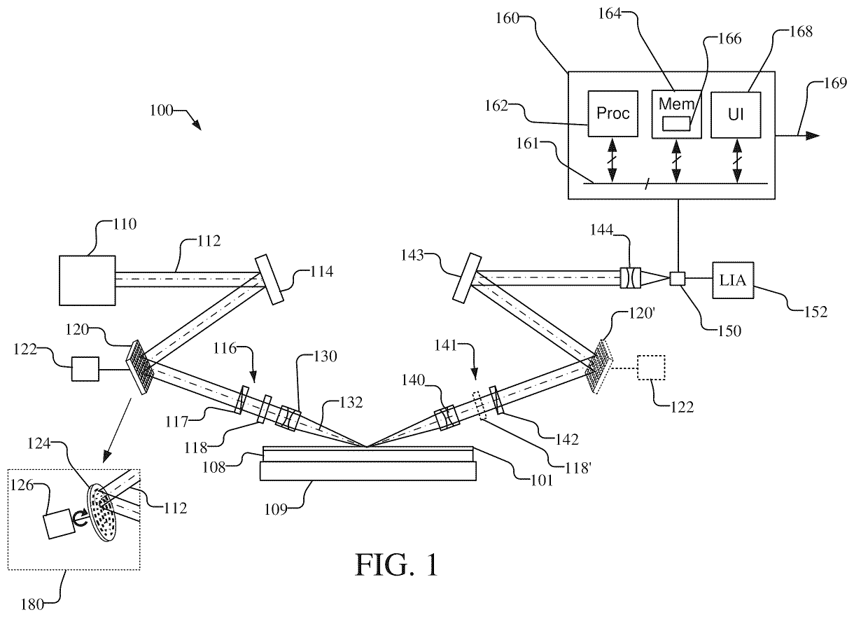

FIG. 1, by way of example, illustrates a schematic view of a metrology device 100 that may be configured for rapid data acquisition at variable angles of incidence, as described herein. The metrology device 100 may be configured, for example, to acquire data at a plurality of angles of incidence with respect to a sample, along an optical axis that is obliquely incident to the sample. The metrology device 100 may be an oblique incidence ellipsometer. If desired, multiple heads, i.e., different metrology devices, may be combined in the same metrology device 100.

The metrology device 100 includes a light source 110 that produces light 112. The light source 110, for example, may be a laser, light emitting diode (LED), a polychromatic light source with a monochromator to select a desired wavelength, or other source that produces narrowband or single wavelength light 112. As illustrated, the light 112 may be directed by optical elements 114 and 120 to focusing optics 130, e.g., objective lens, which directs and focuses the light 112 on the sample 101 along obliquely incident optical axis 132. The optical elements 114 and 120, for example, may be mirrors and in one implementation, optical element 120 may be a digital micromirror device (DMD), and are sometimes referred to herein as DMD 120, to encode the angular distribution of the incident light. In one implementation, shown with dotted lines, the DMD may be on the receiving side of the metrology device 100, e.g., after the sample 101, illustrated by optical element 120′, sometimes referred to herein as DMD 120′, and in this implementation, the optical element 120 on the delivery side of the metrology device 100, e.g., before the sample 101, may be a mirror. In the implementation in which optical element 120 is the DMD, the optical element 120′ on the receiving side of the metrology device may be a mirror. For case of reference, optical elements 120 and 120′ may be collectively referred to as optical element 120 or DMD 120, and unless otherwise stated, the metrology device 100 may be described herein with the DMD on the delivery side of the metrology device 100. The DMD 120 may be coupled to a controller 122, which controls the mirror elements of the DMD 120 to vary the incident angle of the light in a time domain or a frequency domain, as discussed herein. The controller 122, for example, may be part of or separate from a computing system 160.

The metrology device 100 includes a polarization state generator 116, which controls the polarization state of the light 112 that is incident on the sample 101. The polarization state generator 116, for example, may include a polarizer 117, such as a linear polarizer. Additionally, in some implementations, the polarization state generator 116 further includes a high speed polarization state modulator 118, such as a photoelastic modulator (PEM), an acousto-optic modulator (AOM), an electro-optic modulator (EOM), or other axially stationary modulator to control the polarization state of the incident light, and which may have a frequency that is greater than the frequency of the DMD. The use of the high speed polarization state modulator 118, such as a PEM, AOM, or EOM, enables rapid data acquisition because these devices are electrically driven to alter the polarization state of light and, thus, is axially stationary, as opposed to being rotationally driven, i.e., physically rotated, to alter the polarization state of the light. Accordingly, the high speed polarization state modulator 118, such as a PEM, AOM, or EOM, may be referred to herein as an axially stationary polarization state modulator 118 or an electrically driven polarization state modulator 118. In some implementations, a rotating compensator, such as a quarter waveplate or other similar device, may be used as the polarization state modulator 118.

In some implementations, as illustrated with dotted lines, the polarization state modulator 118′ may be located on the receiving side of the metrology device 100 in the polarization state analyzer 141. In some implementations, both the polarization state generator 116 and the polarization state analyzer 141 may include polarization state modulators 118 and 118′, respectively. For ease of reference, the polarization state modulators 118 and 118′ may be collectively referred to as polarization state modulator 118, and unless otherwise stated, the metrology device 100 may be described herein with the polarization state modulator 118 on the delivery side, e.g., in the polarization state generator 116.

Focusing optics 130 focus the incident light onto the sample 101 with a distribution of incidence angles around the optical axis 132. For example, in some implementations, the focusing optics may have a numerical aperture (NA) with a half-angle of at least 5 degrees, 7 degrees, 10 degrees, or more. Optics 140 receive the light from the sample 101 over the distribution of incidence angles around the optical axis 132. The focusing optics 130, 140 may be refractive, reflective, or a combination thereof and may be matching objective lenses.

The reflected light received by optics 140 is received by a polarization state analyzer 141 that may include a polarizer 142, such as a linear polarizer. As noted above, in some implementations, the polarization state analyzer 141 may further include the polarization state modulator 118′. The polarization state analyzer 141 receives the reflected light from the optics 140 and is used to quantify the change in polarization state that is caused by the sample 101. The polarization state analyzer 141 may be static or modulating.

In some implementations, shown with dotted lines, the DMD 120′ may be on the receiving side of the metrology device 100, and may receive light reflected from the sample after it passes through the polarization state analyzer 141. The DMD 120′ may be coupled to the controller 122, which controls the mirror elements of the DMD 120′ to vary the angle of the light that is received in a time domain or a frequency domain, as discussed herein. With use of the DMD 120′ on the receiving side, the optical element 120 on the delivery side of the metrology device 100 may be a mirror or may be eliminated. On the other hand, if the DMD 120 is present on the delivery side of the metrology device 100, DMD 120′ on the receiving side of the metrology device 100 is not present and instead a reflective optical element, e.g., mirror, may be present. As illustrated, one or more additional optical elements 143 may be present, which directs the reflected light received from the polarization state analyzer 141 to a one or more lenses 144 that focuses the light, which is received by a detector 150. The detector 150 has a pixel that detects both the encoded incident angle distribution of the light and the varying polarization states of the light produced by the polarization state modulator. The detector 150, for example, may be a single pixel photodetector or may include an array of pixels, and the single pixel or each pixel in the array of pixels detects both the variations in the incident angles as well as the variation in the polarization state. The detector 150, for example, may be a high speed detector and in some implementations may have a sampling rate that is greater than the frequency of the polarization state modulator 118 and the frequency of the DMD 120. For example, in some implementations, the detector 150 may be a photodetector, such as a photodiode, having a single pixel or a limited number of pixels, each of which detects both the encoded incident angle distribution of the light and varying polarization states of the light. In some implementations, a lock-in amplifier 152 coupled to the detector 150 may be used.

It should be understood that additional optical components may be present in the metrology device. For example, the DMD 120 may have a surface area of approximately 1 cm² and accordingly, additional optics may be present before the DMD 120 to expand the beam to fill the surface of the DMD 120. Additional optics may be present to expand the beam to fill the focusing optics 130.

As illustrated by inset 180 in FIG. 1, instead of using a DMD 120 to encode the angular distribution of the light, the metrology device 100 may use a rotating disk 124 including a plurality of holes and/or reflective elements to encode the angular distribution of the light. In some implementations, the rotating disk 124 may be located on the receiving side and used in place of DMD 120′. The rotating disk 124, for example, may operate in a reflection configuration, in which light 112 is reflected by the rotating disk 124 along the desired the angular distribution of the light, which is altered with the rotation of the rotating disk 124, as controlled by as a motor 126. The rotating disk 124 may exclude undesired incident angles, e.g., using holes in the rotating disk 124. The rotating disk 124 may alternatively operate in a transmission configuration, in which light 112 is transmitted through holes in the rotating disk 124 along the desired the angular distribution of the light, and undesired incident angles are blocked by the rotating disk 124. The encoding of the angular distribution of the light by the rotating disk 124 may be similar to the DMD 120, as described herein, except that the patterns of incident angles is altered due to the rotation of the rotating disk 124, which is controlled by as the motor 126, to encode the angular distribution of the light. The specific pattern of holes and/or reflective elements in the rotating disk 124 is dependent on the desired pattern of incident angles which may be sequentially activated individually or in combination and may be activated in the time domain or frequency domain.

Metrology device 100 further includes at least one computing system 160 that is communicatively coupled to the detector 150 to receive measurement data acquired by the detector 150. The computing system 160 is further configured to control and monitor operation of the metrology device 100, including the light source 110, the DMD 120 (e.g., via the controller 122 if separate from the computing system 160) or rotating disk (e.g., via the motor 126) that may be on either the delivery side or receiving side of the metrology device 100, polarization state generator 116 and polarization state analyzer 141, either of which, or both, include a polarization state modulator 118, detector 150 and lock-in amplifier 152, as well as the chuck 108, stage 109, etc. The computing system 160, for example, may be configured to control the chuck 108 and stage 109 to control the position and orientation of the sample 101 during measurement. The computing system 160 may be configured to control the DMD 120 or rotating disk 124 to encode the angular distribution of the incident light, to control and acquire information from one or more subsystems of the metrology device 100 such as the detector 150 and lock-in amplifier 152, polarization state generator 116 and polarization state analyzer 141 to acquire resulting measurement data, and to determine one or more parameters of the sample 101 based on acquired measurement data. The computing system 160 may be configured to control and acquire data from various one or more subsystems of the metrology device 100, e.g., by a transmission medium that may include wireline and/or wireless portions. The transmission medium, thus, may serve as a data link between the computing system 160 and other subsystems of the metrology device 100.

The at least one computing system 160, for example, may be a workstation, a personal computer, central processing unit or other adequate computer system, or multiple systems. It should be understood that the at least one computing system 160 may be a single computer system or multiple separate or linked computer systems, including one or more processors which may be coupled to one or more computational nodes (blades), which may be interchangeably referred to herein as computing system 160, at least one computing system 160, one or more computing systems 160, etc. In some implementations, the computing system 160 or components of the computing system 160 may be separate from the metrology device 100 while in some implementations, the computing system 160 may be included in or is connected to or otherwise associated with metrology device 100. Additionally, different subsystems of the metrology device 100 may each include a computing system that is configured for carrying out steps associated with the associated subsystem. For example, the at least one computing system 160 may be coupled to a separate computing system that is associated with the detector 150.

The computing system 160 includes at least one processor 162 with memory 164, as well as a user interface (UI) 168, which are communicatively coupled via a bus 161. The memory 164 or other non-transitory computer-usable storage medium, includes computer-readable program code 166 embodied thereof and may be used by the computing system 160 for causing the at least one computing system 160 to control the metrology device 100 and/or to perform functions including encoding the angular distribution of the incident light, as described herein. The data structures and software code for automatically implementing one or more acts described in this detailed description can be implemented by one of ordinary skill in the art in light of the present disclosure and stored, e.g., on a computer-usable storage medium, e.g., memory 164, which may be any device or medium that can store code and/or data for use by a computer system, such as the computing system 160. The computer-usable storage medium may be, but is not limited to, include read-only memory, a random access memory, magnetic and optical storage devices such as disk drives, magnetic tape, etc. Additionally, the functions described herein may be embodied in whole or in part within the circuitry of an application specific integrated circuit (ASIC) or a programmable logic device (PLD), and the functions may be embodied in a computer understandable descriptor language which may be used to create an ASIC or PLD that operates as herein described.

The computing system 160 may be configured to determine one or more characteristics of the sample 101 based on metrology data acquired by detector 150, as well as other metrology device 100 configurations, such as the angular distribution of the incident light and the orientations or states of one or more of the polarization state generator 116 and polarization state analyzer 141. By way of example, the computing system 160 may determine one or more characteristics of the sample 101 using known ellipsometry and other metrology techniques. The results from the analysis may be stored, e.g., in memory 164 associated with the sample and/or provided to a user, e.g., via the UI 168. In some implementations, the results of the analysis may be provided, e.g., via port 169, to other metrology systems to assist with additional measurements or inspection or fed back or fed forward to processing systems for adjusting processing steps in response to the analysis.

The metrology device 100 is advantageously configured to perform variable-angle ellipsometry using a high speed detector 150, which enables rapid data acquisition. In some implementations, a rotating compensator may be used as the polarization state modulator 118. In some implementations, the metrology device 100 may use an axially stationary polarization state modulator 118 instead of a rotating compensator in the polarization state generator 116 or polarization state analyzer 141 to enable rapid polarization state modulation, e.g., with a frequency of 50 kHz. The detector 150 enables high speed data acquisition that is comparable to the axially stationary polarization state modulator 118. For example, the detector 150 may have a sampling rate that is greater than the frequency of the polarization state modulator 118. In some implementations, however, the detector 150 may have a sampling rate that is slightly less than the frequency of the polarization state modulator 118, which although it will waste several cycles of the polarization state modulator 118 while collecting data, may still be useful with the combination of the polarization state modulator 118 and DMD 120. Additionally, the DMD 120 is used to encode the angle of incidence (AOI) of the incident light at either the delivery side or receiving side of the metrology device 100 to provide high speed variable angle measurements.

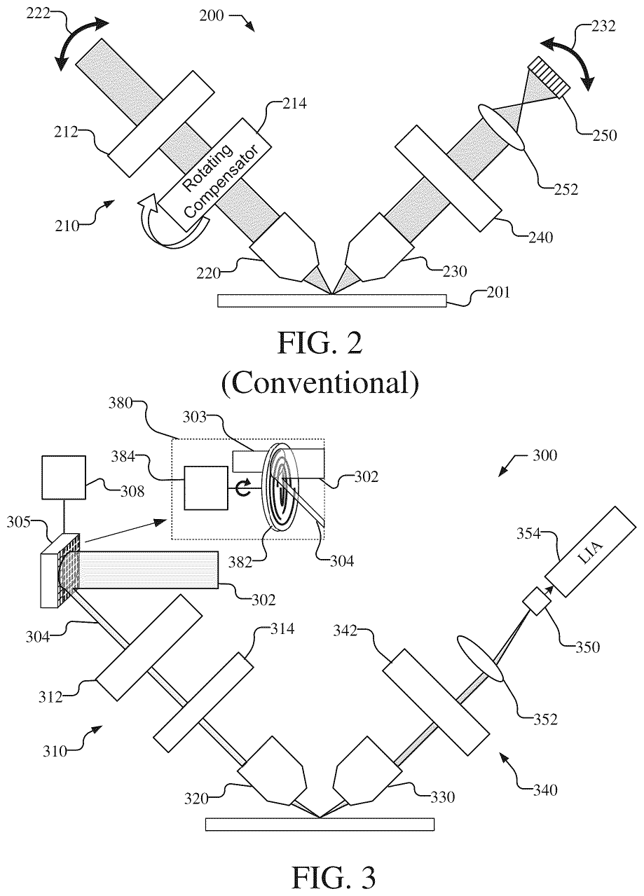

FIG. 2 is a side view of a portion of conventional variable-angle ellipsometer 200. The ellipsometer 200 is illustrated with a polarization state generator 210 including a polarizer 212 and a rotating compensator 214, and lens 220 on the delivery side, and a lens 230, analyzer 240, e.g., a polarizer, and a lens 252 and detector array 250 on the receiving side. The rotating compensator 214, for example, may be a quarter wave plate or other retarding element, that is physically rotated about the optical axis by a driver.

In some conventional implementations, the variable angle ellipsometer 200 may vary the incident angle of the incident light by physically moving the delivery and receiving arms of the ellipsometer 200, as illustrated by arrows 222 and 232, respectively, using a goniometer. The use of movable arms of the ellipsometer 200, however, requires physical movement resulting in vibrations and a slow data acquisition time.

In another conventional implementations, the variable angle ellipsometer 200 may hold the delivery and receiving arms in a fixed orientation, and may use a lens 220 that focuses the light on the sample 201 over a number of incident angles. The detector array 250, which may be a charge coupled device (CCD) or similar type of array detector, is used to detect and discriminate the different incident angles produced by the lens 220. With the use of the lens 220 and detector array 250, a number of angles of incidence may be detected without requiring physical movement of the delivery and receiving arms. The ellipsometer 200, however, still includes the use of a rotating compensator 214, which requires physical movement resulting in vibrations and limits the data acquisition time.

In some implementations, e.g., to increase the data acquisition time for a variable angle ellipsometer and to reduce vibration, it may be desirable to replace the rotating compensator 214 with a high speed, polarization state modulator. The presence of the detector array 250 in a conventional system, however, limits the speed of the data acquisition.

FIG. 3 is a side view of a portion of a variable-angle ellipsometer 300 capable of high speed data acquisition using a polarization state modulator, a detector, and a DMD to encode the angle of incidence of light with a high sampling rate, as discussed herein. The portion of the variable-angle ellipsometer 300 shown in FIG. 3, by way of example, may include one or more of the components illustrated in metrology device 100 shown in FIG. 1. FIG. 3 illustrates the DMD and the polarization state modulator on the delivery side of the metrology device, e.g., before the sample, but as illustrated in FIG. 1, the DMD and the polarization state modulator may be located on the receiving side of the metrology device, e.g., after the sample. In some implementations, the variable-angle ellipsometer 300 may use a rotating disk 382 in place of the DMD 305, as illustrated inset 380, to encode the angle of incidence of light with a high sampling rate, but otherwise the operation of the variable-angle ellipsometer 300 may be the same.

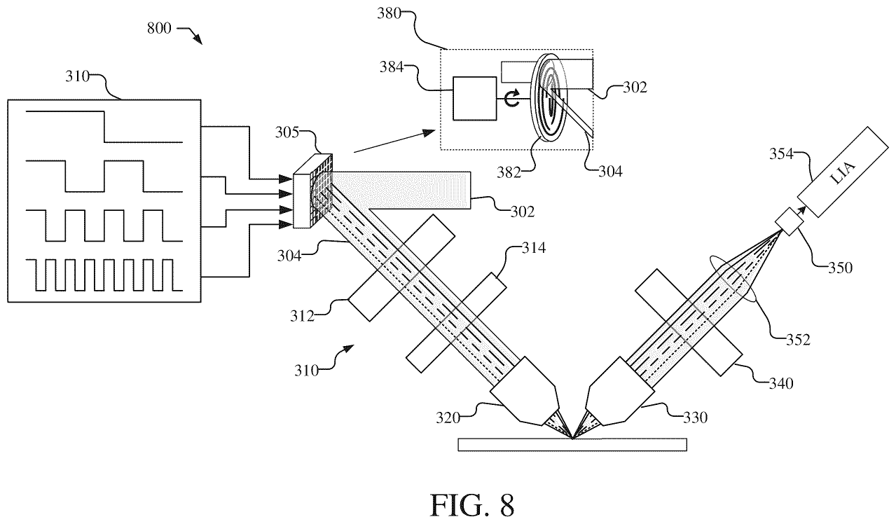

As illustrated, the ellipsometer 300 includes a DMD 305 that encodes the angular distribution of the incident light. The DMD 305 includes a plurality of microscopic mirror elements (sometimes referred to as pixels) that are controlled individually or in groups to be in an on or off state to control the angle of incidence of the light that is incident on the sample. For example, as illustrated, the DMD 305 may receive the full beam 302 of incident light and may turn on one or more pixels to reflect a portion 304 of the incident light towards the sample at a desired angle of incidence. The other pixels in the DMD 305 are turned off, e.g., by directing the light away from the sample, such as to a beam dump (not shown). A controller 308 is coupled to the DMD and may control the mirror elements of the DMD 305 to encode the angular distribution of incident light. For example, as illustrated in FIG. 3, the controller 308 may select one or more mirror elements or groups of mirror elements to vary the incident angle of light in a time domain. As discussed in reference to FIG. 8, the controller 308 may select one or more mirror elements or groups of mirror elements to vary the incident angle of light in a frequency domain. The controller 308, for example, may be part of the computing system 160 (shown in FIG. 1) or may be a separate component that is coupled to and controlled by the computing system 160.

In some implementations, the DMD 305 may be located on the receiving of the metrology device, as illustrated in FIG. 1. The operation of the DMD 305 if located on the receiving side would be similar to the operation of the DMD 305, except that the full beam 302 is incident on the sample and the DMD 305 on the receiving side is controlled to select the angle of incidence of the reflected light that is provided to the detector 350.

The ellipsometer 300 is illustrated as including a polarization state generator 310 including a polarizer 312 and a polarization state modulator 314, which may be, e.g., a rotating compensator or an axially stationary polarization state modulator, such as a PEM, AOM, EOM, or similarly fast non-rotating modulator, and a lens 320 on the delivery side that provides a distribution of incident angles, and a lens 330, polarization state analyzer 340 including a polarizer 342, and detector 350, such as a photodiode on the receiving side. In some implementations, the polarization state modulator 314 may be located in the polarization state analyzer 340 on the receiving side or both the polarization state generator 310 and the polarization state analyzer 340 may include polarization state modulators, as illustrated in FIG. 1. As illustrated, a lens 352 may be used to focus the received light on the detector 350, and in some implementations, a lock-in amplifier 354 may be connected to the detector 350 and used to assist in decoding the angular distribution of the incident light produced by the DMD 305.

With ellipsometer 300, the acquisition speed is greatly increased compared to a conventional variable angle ellipsometer, such as ellipsometer 200 shown in FIG. 2. In some implementations, a rotating compensator may be used as the polarization state modulator 314, e.g., similar to FIG. 2. In some implementations, however, by eliminating a physically rotating compensator and instead using an axially stationary polarization state modulator 314, in the polarization state generator 310 and/or the polarization state analyzer 340, the speed at which the light is modulated is significantly increased. Moreover, with use of a high speed detector 350, such as a single pixel detector, the speed of the data acquisition is no longer limited by the read-out time of a CCD array. Without a detector array capable of detecting and discriminating the different incident angles of light, as illustrated in FIG. 2, achieving the variation in the angle of incidence would be problematic in a conventional ellipsometer, such as ellipsometer 200 shown in FIG. 2. For example, as illustrated in FIG. 2, a conventional ellipsometer may vary the incident angle of light by physically moving the delivery and receiving arms of the ellipsometer 200, illustrated by arrows 222 and 232, respectively, using a goniometer, which reduces data acquisition speed and produces in accuracies, e.g., due to vibration. Ellipsometer 300, on the other hand, uses the DMD 305 and lens 320 to vary the angle of incidence of the light. The DMD 305 can operate at high speeds, e.g., 38 kHz sampling rate, which enables high speed data acquisition at multiple angles of incidence.

The DMD 305 may be controlled, e.g., by a processor, such as in computing system 160 shown in FIG. 1, to encode the angular distribution of the incident light. For example, a DMD 305 on the delivery side may be controlled to directly select the angle of light incidence on the sample, or a DMD 305 on the receiving side may be controlled to filter out light reflected from the sample that corresponds to unwanted angles of incidence (on the sample) before the light reaches the detector 350, e.g. or to say it in another way, the DMD 305 on the receiving side may be controlled to select the angle of incidence (on the sample) of the light that is provided to the detector 350. The angular distribution of incident light may be encoded in various fashions. For example, in one implementation, the DMD 305 may encode the angular distribution of incident light in the time domain, e.g., by sequentially scanning the angles of incidence individually or in groups. In one implementation, the DMD 305 may encode the angular distribution of incident light in the frequency domain, e.g., by modulating each angle of incidence with a different frequency.

In general, the signal received at the detector 350 may be represented as

$$y = Mx + d \qquad eq . 1$$

where x is a vector representing the light intensity reflected off the sample at each incident angle (i.e., the data that is needed for the desired measurement), M is a vector representing the active and inactive elements (i.e., on and off pixels) of the DMD 305, y is the intensity detected at the detector 350, and d is dark noise in the system. The vector M may also be translated into the incident angles.

In some implementations, as illustrated by inset 380, the variable-angle ellipsometer 300 may use a rotating disk 382 in place of the DMD 305 to encode the angle of incidence of light with a high sampling rate. As illustrated by inset 380, the rotating disk 382 may include a plurality of holes and/or reflective elements to encode the angular distribution of the light. The rotating disk 382 may receive the full beam 302 of incident light and may reflect a portion 304 of the incident light towards the sample at a desired angle of incidence, while the remaining portion 303 of light is transmitted through holes in the rotating disk 382 and is a received by a beam dump (not shown) or is otherwise directed away from the sample. In another implementation, the rotating disk 382 may operate in transmission mode, e.g., with light transmitted through holes in the rotating disk 382 being directed towards the sample a desired angle of incidence, and the remaining portion of light is reflected by the rotating disk away from the sample. As the rotating disk 382 rotates the full beam 302 of incident light is received by other patterns of holes and/or reflective elements which alters the incident angle of the light on the sample. The detector 350 (or lock-in amplifier 354) may be synchronized with rotating disk 382 to sample the reflected light when the desired incident angle is fully illuminated. The sequence of incident angles, e.g., in the time domain or frequency domain, is determined by the pattern of the rotating disk as well as the motor 384 controlling the rotational velocity of the rotating disk 382. As discussed with respect to the DMD 305, the rotating disk 382 may be present on either the delivery side or the receiving side of the metrology device.

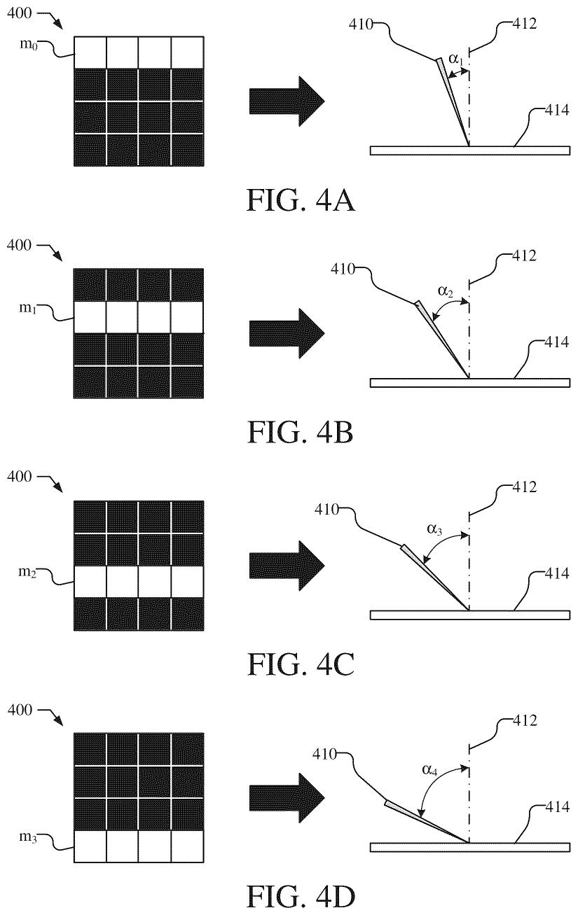

FIGS. 4A-4D, by way of example, illustrate a sequential angle-scanning sequence and the translation of active and inactive mirror elements of the DMD into discrete incident angles that may be used to encode the angle of incidence of light in the time domain.

FIGS. 4A-4D, for example, illustrates a pixel array 400 of a DMD, such as DMD 120 shown in FIG. 1 or DMD 305 shown in FIG. 3 that is present on the delivery side of the metrology device. White pixels in the pixel array 400 in each of FIGS. 4A-4D are pixels that are active, i.e., in an on state to reflect a portion of the incident light towards the sample at a desired angle of incidence, while dark pixels in the pixel array 400 are inactive, i.e., in an off state to direct the light away from the sample. In implementations in which the DMD is located on the receiving side of the metrology device, the sequential angle-scanning operation of the DMD is similar to that shown in FIGS. 4A-4D, but the incident light would include all incident angles, and the DMD is used to select which of the incident angles are provided to the detector.

Each of FIGS. 4A-4D illustrates a different row of pixels being active, identified as mirror elements m₀, m₁, m₂, and m₃, respectively. It should be understood that while the active mirror elements are illustrated as a single row of pixels, the active mirror elements may be a plurality of adjacent rows of pixels that are combined to direct the desired portion of the incident light towards the sample at the desired angle of incidence. FIGS. 4A-4D further illustrate the angles of incidence of light 410 that result from active mirror elements m₀, m₁, m₂, and m₃. FIGS. 4A-4D, for example, illustrate the angles of incidence α₀, α₁, α₂, and α₃, respectively, of the incident light 410 with respect to the normal vector 412 of the sample 414. It should be understood, of course, that the angle of incidence may be measured in other manners, such as the offset from the center of the optical axis 132 shown in FIG. 1.

As illustrated in FIGS. 4A-4D, the DMD may turn on each row of pixels m₁, m₂, m₃, m₄ in a sequence to vary the angle of incidence over the desired range of angles α₀, α₁, α₂, and α₃. It should be understood that while FIGS. 4A-4D illustrates mirror elements being activated (turned on) in an ordered sequence, e.g., from the top of the pixel array 400 to the bottom of the pixel array 400, different sequence orders may be used.

With respect to a discrete angle scanning implementation, as illustrated in FIGS. 4A-4D, the measured intensity corresponding to a particular incident angle is simply the light that is reflected from the sample at that angle. For the condition in which only the first mirror element m₀ (as illustrated in FIG. 4A) reflects light to the sample (e.g., only the reflectance for the steepest incident angle, x₀, is being measured), the total measured signal, y, may be expressed as follows:

$$y = 1 * {x}_{0} + 0 * {x}_{1} + 0 * {x}_{2} + 0 * {x}_{3} \qquad eq . 2$$

or, in matrix notation:

$$y = ( 1000 ) ( \begin{matrix}{x}_{0} \\ {x}_{1} \\ {x}_{2} \\ {x}_{3}\end{matrix} ) . \qquad eq . 3$$

Similarly, the condition in which only the second mirror element m₁ (as illustrated in FIG. 4B) is active may be expressed as:

$$y = 0 * {x}_{0} + 1 * {x}_{1} + 0 * {x}_{2} + 0 * {x}_{3} \qquad eq . 4$$

or, in matrix notation:

$$y = ( 0100 ) ( \begin{matrix}{x}_{0} \\ {x}_{1} \\ {x}_{2} \\ {x}_{3}\end{matrix} ) . \qquad eq . 5$$

Scanning through each angle sequentially, as illustrated in FIGS. 4A-4D, generates four equations, which may be combined and written as the matrix expression:

$$( \begin{matrix}{y}_{0} \\ {y}_{1} \\ {y}_{2} \\ {y}_{3}\end{matrix} ) = ( \begin{matrix}1 & 0 & 0 & 0 \\ 0 & 1 & 0 & 0 \\ 0 & 0 & 1 & 0 \\ 0 & 0 & 0 & 1\end{matrix} ) ( \begin{matrix}{x}_{0} \\ {x}_{1} \\ {x}_{2} \\ {x}_{3}\end{matrix} ) . \qquad eq . 6$$

where y is now subscripted to denote which condition is being measured. In matrix notation, this could be solved by multiplying both sides by the inverse of the matrix M:

$$y = Mx \qquad eq . 7$$

$${M}^{- 1} y = {M}^{- 1} Mx \qquad eq . 8$$

$${M}^{- 1} y = x \qquad eq . 9$$

With the discrete angle scanning implementation, as illustrated in FIGS. 4A-4D, the matrix M is the identity matrix, and accordingly, y₀=x₀, y₁=x₁, etc., ignoring the dark noise d in the system. The dark noise d in the system is random and impacts any solution to the expression representing the received signal. Thus, one drawback of the discrete angle scanning implementation, as illustrated in FIGS. 4A-4D, is that at any time only about one fourth of the total light intensity reaches the detector at any time. With a higher angular resolution, this fraction reduces even further. In this case, the dark noise, d, has a greater effect on the data, i.e., the signal to noise ratio increases.

In some implementations, as discussed above, a rotating disk may be used in place of a DMD, and the encoding of the angle of incidence of light in the time domain based on sequential angle-scanning sequence may be similarly performed using holes and/or mirror elements of the rotating disk.

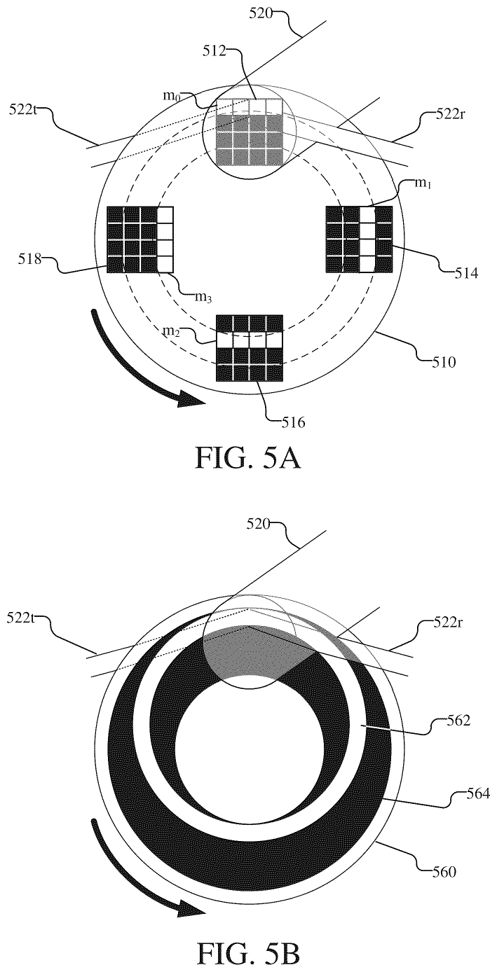

FIGS. 5A and 5B, for example, illustrate examples of rotating disks 510 and 560, respectively, that may be used in place of the DMD illustrated in FIGS. 4A-4D. FIG. 5A illustrates a rotating disk 510 that includes a plurality of pixel arrays 512, 514, 516, and 518, that with rotation of the rotating disk 510 perform a sequential angle-scanning sequence with discrete incident angles similar to that illustrated in FIGS. 4A-4D. The rotating disk 510 rotates in discrete steps, as illustrated by the arrow, to place each pixel array sequentially in the incident light 520. In FIG. 5A, white pixels are pixels that are active, e.g., direct incident light 520 to the sample at a desired angle of incidence as either reflected light 522r or transmitted light 522t, while dark pixels are inactive, e.g., prevent incident light 520 from being directed to the sample. It should be understood that individual pixels are shown in FIG. 5A for the sake of illustration, and that the illustrated white (active) pixels may be a single (or multiple) reflective element or a single (or multiple) transmission element, e.g., a single mirror to produce reflected light 522r, or a single a hole in the rotating disk 510 to produce transmitted light 522t. Moreover, the illustrated dark (inactive) pixels may be a single (or multiple) absorbing elements or holes in the rotating disk 510 to prevent incident light 520 from being directed to the sample, or may simply be opaque if the active elements are transmissive or holes. For example, if the rotating disk 510 operates in transmission mode, e.g., active pixels produce transmitted light 522t, the dark (inactive) pixels need not be physically represented on the rotating disk 510, but may simply be the opaque material of the rotating disk 510 itself.

FIG. 5B illustrates a rotating disk 560 that with rotation of the rotating disk 560 performs a continuous angle-scanning sequence with discrete incident angles similar to that illustrated in FIGS. 4A-4D The rotating disk for example, may include one or more continuous active (white) elements 562, which may direct incident light 520 to the sample at a desired angle of incidence as either reflected light 522r or transmitted light 522t, and one or more continuous inactive (dark) elements 564 that prevent incident light 520 from being directed to the sample. As discussed in FIG. 5A, the one or more active elements 562 may be reflective to produce reflected light 522r, or may be transmissive, e.g., holes, to produce transmitted light 522t. The inactive elements 564 may be absorbing elements or holes in the rotating disk 560, e.g., if the active elements 562 are reflective, or may simply be opaque if the active elements 562 are transmissive or holes.

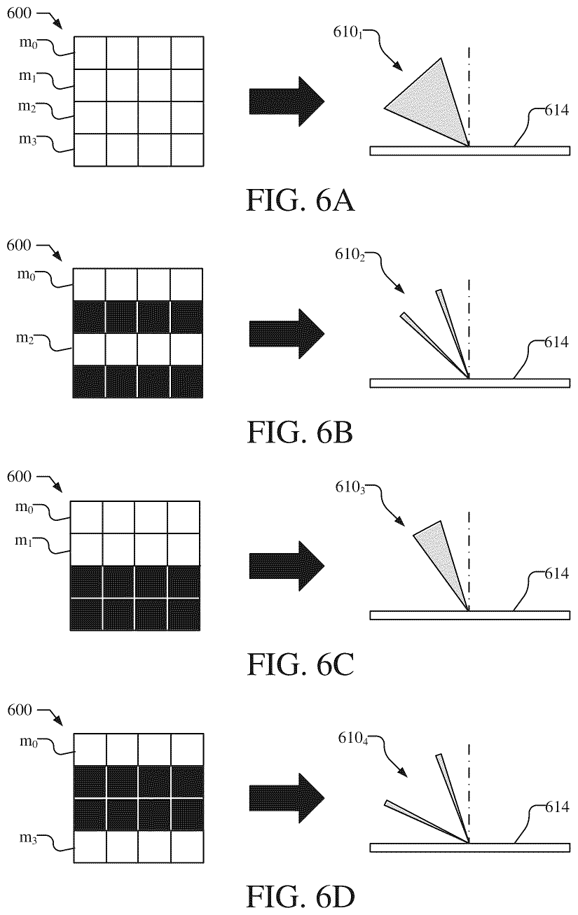

FIGS. 6A-6D, by way of example, illustrate an angle-scanning sequence and the translation of active and inactive mirror elements of the DMD into combinations of incident angles that may be used to encode the angle of incidence of light in the time domain. FIGS. 6A-6D are similar to FIGS. 4A-4D, but show that a plurality of adjacent and/or non-adjacent rows of pixels may be activated to produce various combinations of incident angles in a sequence.

FIGS. 6A-6D, for example, illustrates a pixel array 600 of a DMD, which is similar to pixel array 400 shown in FIGS. 4A-4D, white pixels are in an on state, e.g., to reflect a portion of the incident light towards the sample 614 at a desired angle of incidence, and dark pixels are in an off state, e.g., to direct the light away from the sample 614. As illustrated in FIGS. 6A-6D different combinations of mirror elements m₀, m₁, m₂, and m₃ may be active to sample different combinations of incident angles of the incident light 610₁, 610₂, 610₃, 610₄. FIGS. 6A-6D illustrate operation if the DMD is located on the deliver side. In implementations in which the DMD is located on the receiving side of the metrology device, the operation of the DMD is similar to that shown in FIGS. 6A-6D, but the incident light would include all incident angles, and the DMD is used to select which of the incident angles are provided to the detector.

Thus, as illustrated in FIGS. 6A-6D, instead of sampling only one discrete angle at a time to form the basis vectors of the matrix M, combinations of angles may be sampled, e.g., if (1) all of the required angles are sampled, (2) the resulting matrix can be solved, and (3) the elements of the resulting matrix are binary (because the mirror elements of the DMD can either deliver light to the detector, creating a “1”, or it can deflect it away from the detector, creating a “0”). This third requirement is not so strict, as with proper the measurement of properly selected angles and manipulation of the resulting matrices, the elements of the resulting matrix may be non-binary, such as a “−1.” The use of combinations of incident angles may be used advantageously, e.g., to improve the signal to noise ratio, while still enabling reconstruction of the data for separate incident angles.

In order to solve the resulting matrix equation, the matrix needs to be invertible. Additionally, because the DMD uses mirrors that are switched on and off, the matrix elements must be binary. In one implementation, a Hadamard matrix may be used, which is easily inverted. There are many ways to generate a Hadamard matrix, but the most common is a matrix of the form:

$$( \begin{matrix}a & a \\ a & - a\end{matrix} ) \qquad eq . 10$$

where the elements represented by “a” may be smaller matrices of the same form. By way of example, in the case of a 4×4 matrix, this would result in the following expression:

$$( \begin{matrix}{y}_{0} \\ {y}_{1} \\ {y}_{2} \\ {y}_{3}\end{matrix} ) = ( \begin{matrix}1 & 1 & 1 & 1 \\ 1 & - 1 & 1 & - 1 \\ 1 & 1 & - 1 & - 1 \\ 1 & - 1 & - 1 & 1\end{matrix} ) ( \begin{matrix}{x}_{0} \\ {x}_{1} \\ {x}_{2} \\ {x}_{3}\end{matrix} ) \qquad eq . 11$$

As noted in equation 11, however, there are non-binary matrix elements of −1, which need to be generated. One way to generate the −1 values is to collect two binary matrices in which 0s are substituted for −1's in the first matrix and 1's in the second matrix and subtract the two matrices. Thus, two sets of measurements may be performed. By way of example, a first measurement (labelled as ‘a’) is illustrated in FIGS. 6A-6D, which may be expressed as:

$$( \begin{matrix}{y}_{0 a} \\ {y}_{1 a} \\ {y}_{2 a} \\ {y}_{3 a}\end{matrix} ) = ( \begin{matrix}1 & 1 & 1 & 1 \\ 1 & 0 & 1 & 0 \\ 1 & 1 & 0 & 0 \\ 1 & 0 & 0 & 1\end{matrix} ) ( \begin{matrix}{x}_{0} \\ {x}_{1} \\ {x}_{2} \\ {x}_{3}\end{matrix} ) . \qquad eq . 12$$

A second measurement (labelled ‘b’), similar to that shown in FIGS. 6A-6D, but with the active and inactive elements reversed, may be performed to produce the following expression:

$$( \begin{matrix}{y}_{0 b} \\ {y}_{1 b} \\ {y}_{2 b} \\ {y}_{3 b}\end{matrix} ) = ( \begin{matrix}0 & 0 & 0 & 0 \\ 0 & 1 & 0 & 1 \\ 0 & 0 & 1 & 1 \\ 0 & 1 & 1 & 0\end{matrix} ) ( \begin{matrix}{x}_{0} \\ {x}_{1} \\ {x}_{2} \\ {x}_{3}\end{matrix} ) . \qquad eq . 13$$

The subtraction of the two expressions shown in equations 12 and 13 may be expressed as:

$$( \begin{matrix}{y}_{0 a} \\ {y}_{1 a} \\ {y}_{2 a} \\ {y}_{3 a}\end{matrix} ) - ( \begin{matrix}{y}_{0 b} \\ {y}_{1 b} \\ {y}_{2 b} \\ {y}_{3 b}\end{matrix} ) = ( \begin{matrix}1 & 1 & 1 & 1 \\ 1 & 0 & 1 & 0 \\ 1 & 1 & 0 & 0 \\ 1 & 0 & 0 & 1\end{matrix} ) ( \begin{matrix}{x}_{0} \\ {x}_{1} \\ {x}_{2} \\ {x}_{3}\end{matrix} ) - ( \begin{matrix}0 & 0 & 0 & 0 \\ 0 & 1 & 0 & 1 \\ 0 & 0 & 1 & 1 \\ 0 & 1 & 1 & 0\end{matrix} ) ( \begin{matrix}{x}_{0} \\ {x}_{1} \\ {x}_{2} \\ {x}_{3}\end{matrix} ) \qquad eq . 14$$

$$( \begin{matrix}{y}_{0 a} - {y}_{0 b} \\ {y}_{1 a} - {y}_{1 b} \\ {y}_{2 a} - {y}_{2 b} \\ {y}_{3 a} - {y}_{3 b}\end{matrix} ) = ( ( \begin{matrix}1 & 1 & 1 & 1 \\ 1 & 0 & 1 & 0 \\ 1 & 1 & 0 & 0 \\ 1 & 0 & 0 & 1\end{matrix} ) - ( \begin{matrix}0 & 0 & 0 & 0 \\ 0 & 1 & 0 & 1 \\ 0 & 0 & 1 & 1 \\ 0 & 1 & 1 & 0\end{matrix} ) ) ( \begin{matrix}{x}_{0} \\ {x}_{1} \\ {x}_{2} \\ {x}_{3}\end{matrix} ) \qquad eq . 15$$

Subtracting the elements of the matrix elements from one another generates the Hadamard matrix in an expression of the form.

$$( \begin{matrix}{y}_{0 a} - {y}_{0 b} \\ {y}_{1 a} - {y}_{1 b} \\ {y}_{2 a} - {y}_{2 b} \\ {y}_{3 a} - {y}_{3 b}\end{matrix} ) = ( \begin{matrix}1 & 1 & 1 & 1 \\ 1 & - 1 & 1 & - 1 \\ 1 & 1 & - 1 & - 1 \\ 1 & - 1 & - 1 & 1\end{matrix} ) ( \begin{matrix}{x}_{0} \\ {x}_{1} \\ {x}_{2} \\ {x}_{3}\end{matrix} ) \qquad eq . 16$$

Accordingly, an expression consisting of the measured signals (yₐ−y_{b}) is generated in terms of x and a Hadamard matrix. This expression can now be solved for x by applying the inverse of the Hadamard matrix to both sides.

$${y}_{a} - {y}_{b} = Hx \qquad eq . 17$$

$${H}^{- 1} ( {y}_{a} - {y}_{b} ) = {H}^{- 1} Hx \qquad eq . 18$$

$${H}^{- 1} ( {y}_{a} - {y}_{b} ) = x . \qquad eq . 19$$

Notice that other than the collection of data corresponding to y_{0b}, the detector always receives about half of the available light for the example shown in FIGS. 6A-6D, as opposed to one fourth, as was the case with discrete angle scanning shown in FIGS. 4A-4D. If higher resolution is desired, the number of elements in each row of the matrix will increase, and discrete angle scanning will sample even less of the total amount of light (1/N, where N is the number of elements in the matrix), while the Hadamard approach always allows the detector to use about half of the available light, thereby improving the signal to noise ratio.

It should be understood that the above expressions are one of many possible approaches to increase the amount of light reaching the detector. Hadamard refers to a class of matrices, and the example above is one example of a Hadamard matrix that may be used. Additionally, other types of matrices may be used, which can be generated using a DMD, some of which may be more efficient, for example, measurement of two full data sets may not be required.

In some implementations, as discussed above, a rotating disk may be used in place of a DMD, and the encoding of the angle of incidence of light in the time domain based on sequential angle-scanning sequence may be similarly performed using holes and/or mirror elements of the rotating disk.

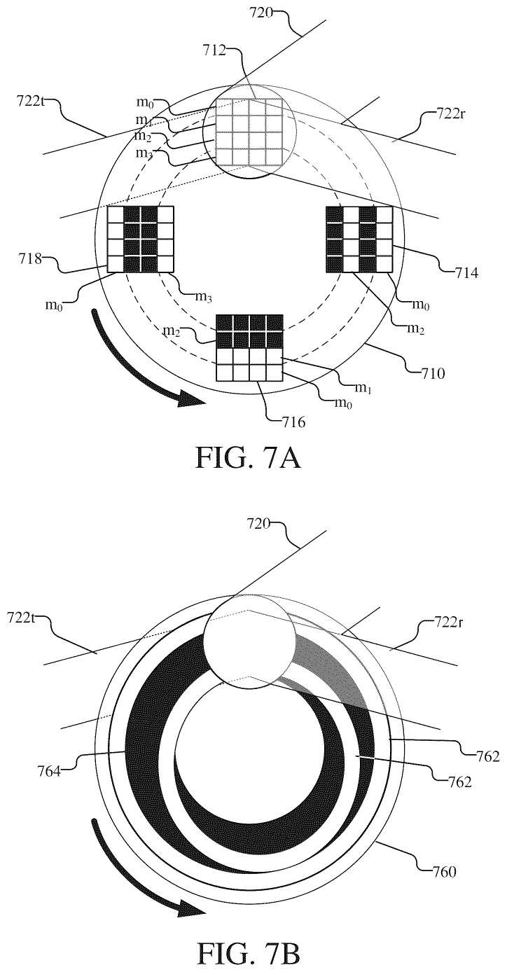

FIGS. 7A and 7B, for example, illustrate examples of rotating disks 710 and 760, respectively, that may be used in place of the DMD illustrated in FIGS. 6A-6D. FIG. 7A illustrates a rotating disk 710 that includes a plurality of pixel arrays 712, 714, 716, and 718, that with rotation of the rotating disk 710 perform a sequential angle-scanning sequence with combinations of incident angles similar to that illustrated in FIGS. 6A-6D. The rotating disk 710 rotates in discrete steps, as illustrated by the arrow, to place each pixel array sequentially in the incident light 720. In FIG. 7A, white pixels are pixels that are active, e.g., direct incident light 720 to the sample at a desired angle of incidence as either reflected light 722r or transmitted light 722t, while dark pixels are inactive, e.g., prevent incident light 720 from being directed to the sample. It should be understood that individual pixels are shown in FIG. 7A for the sake of illustration, and that the illustrated white (active) pixels may be a single (or multiple) reflective element or a single (or multiple) transmission element, e.g., a single mirror to produce reflected light 722r, or a single a hole in the rotating disk 710 to produce transmitted light 722t. Moreover, the illustrated dark (inactive) pixels may be a single (or multiple) absorbing elements or holes in the rotating disk 710 to prevent incident light 720 from being directed to the sample, or may simply be opaque if the active elements are transmissive or holes. For example, if the rotating disk 710 operates in transmission mode, e.g., active pixels produce transmitted light 722t, the dark (inactive) pixels need not be physically represented on the rotating disk 710, but may simply be the opaque material of the rotating disk 710 itself.

FIG. 7B illustrates a rotating disk 760 that with rotation of the rotating disk 760 performs a continuous angle-scanning sequence with combinations of incident angles similar to that illustrated in FIGS. 6A-6D. The rotating disk for example, may include one or more continuous active (white) elements 762, which may direct incident light 720 to the sample at a desired angle of incidence as either reflected light 722r or transmitted light 722t, and one or more continuous inactive (dark) elements 764 that prevent incident light 720 from being directed to the sample. As discussed in FIG. 7A, the one or more active elements 762 may be reflective to produce reflected light 722r, or may be transmissive, e.g., holes, to produce transmitted light 722t. The inactive elements 764 may be absorbing elements or holes in the rotating disk 760, e.g., if the active elements 762 are reflective, or may simply be opaque if the active elements 762 are transmissive or holes.

As noted above, in one implementation, the DMD may encode the angular distribution of incident light in the frequency domain, e.g., by modulating each angle of incidence with a different frequency. By operating in the frequency domain, the amount of light that reaches the detector may be further increased, thereby further improving the signal to noise ratio.

FIG. 8 is a side view of a portion of the variable-angle ellipsometer 800 capable of high speed data acquisition using a DMD to encode the AOI of incident light in the frequency domain. The variable-angle ellipsometer 800 shown in FIG. 8 is similar to variable-angle ellipsometer 300, shown in FIG. 3, and includes a DMD 305, a polarization state generator 310 and a polarization state analyzer 340 including polarizers 312 and 342, respectively, and either or both may include an polarization state modulator 314, lenses 320 and 330, and a detector 350, as well as one or more lenses 352 to focus the received light on the detector 350, and a lock-in amplifier 354. FIG. 8 illustrates operation with the DMD 305 located on the deliver side. In implementations in which the DMD 305 is located on the receiving side, the operation of the DMD is similar to that shown in FIGS. 6A-6D, but the incident light would include all incident angles, and the DMD is used to encode the AOI of incident light in the frequency domain from the receiving side. In some implementations, as discussed above and similar to the illustrations of FIGS. 3, 5A, 5B, 7A, and 7B, the variable-angle ellipsometer 300 may use a rotating disk 382 in place of the DMD 305, as illustrated inset 380, to encode the angle of incidence of light in the frequency domain with a high sampling rate, but otherwise the operation of the variable-angle ellipsometer 300 may be the same.

The controller 308 in the ellipsometer 800 operates as a waveform generator that controls mirror elements of the DMD 305 to encode the angular distribution of incident light in the frequency domain. The controller 308, for example, may be the computing system 160 (shown in FIG. 1) or may be a separate component that is coupled to and controlled by the computing system 160. The controller 308 is illustrated as producing four waveforms that control mirror elements, e.g., rows of pixels, of the DMD 305 to frequency modulate four different angles of incidence, as illustrated by the solid and dashed lines. Of course, if desired, a higher angular resolution may be produced using additional mirror elements and corresponding increase in waveforms.

The reflected light from the sample is received by the detector 350, and the lock-in amplifier 354 demodulates the frequency of the detected light, based on the waveforms generated by the controller 308 to decode the angular distribution of the light.

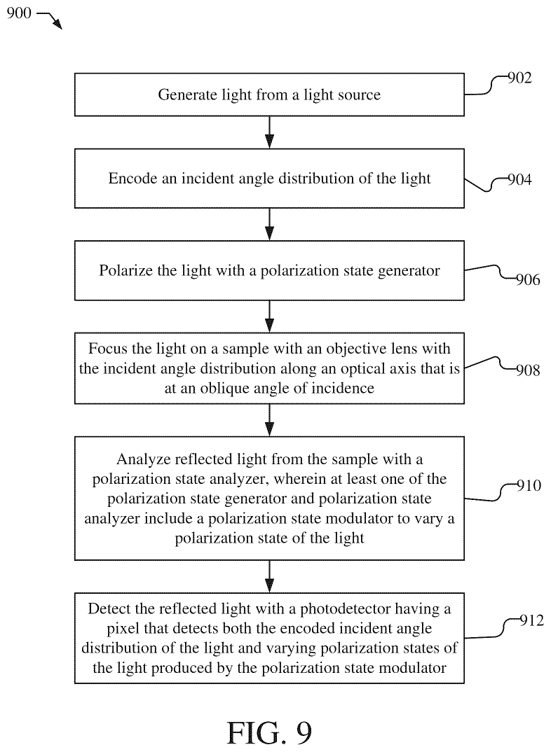

FIG. 9 shows an illustrative flowchart depicting an example method 900 for performing variable angle ellipsometry, according to some implementations. In some implementations, the example method 900 may be performed by a metrology device, such as an ellipsometer, that includes a digital micromirror device or rotating disk to encode the incident angle distribution of light, a polarization state generator or polarization state analyzer, at least one of which includes a polarization state modulator, such as a rotating compensator, or in some implementations, a photoelastic modulator, an acousto-optic modulator, or an electro-optic modulator, and a photodetector having a pixel that receives the reflected light and detects both the encoded incident angle distribution of the light and varying polarization states of the light produced by the polarization state modulator. The metrology devices, for example, may be a variable angle ellipsometer, such as illustrated in FIG. 1 or FIG. 3.

As illustrated in FIG. 9, the method includes generating light from a light source (902). For example, the light may be narrowband or single wavelength light produced by a laser, LED, or a polychromatic light source with a monochromator to select a desired wavelength, e.g., as illustrated by light source 110 producing light 112 in FIG. 1.

The method further includes encoding an incident angle distribution of the light (904). For example, a means for encoding the incident angle distribution of the light may be a digital micromirror device or a rotating disk, as discussed in respect to FIGS. 1 and FIGS. 3-8. The encoding of the incident angle distribution of light may include selecting the incident angle of the light in a time domain or a frequency domain, e.g., as discussed in respect to FIG. 1 and FIGS. 3-8. In some implementations, a means for encoding the incident angle distribution of the light may be located before the sample and may encode the incident angle distribution of the light before the light is incident on the sample, e.g., as illustrated by DMD 120 or rotating disk 124 in FIG. 1. In some implementations, a means for encoding the incident angle distribution of the light may be located after the sample and may encode the incident angle distribution of the light after the light is reflected from the sample, e.g., as illustrated by DMD 120′ in FIG. 1 and discussed in reference to rotating disk 124.

The light is polarized with a polarization state generator, which may include a polarizer (906), such as illustrated in FIG. 1. The polarization state generator, for example, may include a polarizer as illustrated, for example, in FIGS. 1, 3, and 8.

The light is focused on the sample with an objective lens with the incident angle distribution along an optical axis that is at an oblique angle of incidence (908). For example, as illustrated in FIGS. 1 and 3-8, the ellipsometer may have an optical axis 132 that is at an oblique angle of incidence, and an objective lens, e.g., focusing optics 130, focuses the light on a sample over a distribution of incident angles along the optical axis 132. For example, the objective lens may have an NA with a half-angle of at least 5 degrees.

The reflected light from the sample is analyzed with a polarization state analyzer (910). The polarization state analyzer, for example, may include a polarizer that is used to analyze the polarization state of the reflected light to quantify the change in polarization state caused by the sample. At least one of the polarization state generator and polarization state analyzer include a polarization state modulator, such as a rotating compensator, or in some implementations, a photoelastic modulator, an acousto-optic modulator, or an electro-optic modulator or other polarization state modulator, to vary a polarization state of the light. In some implementations, the polarization state modulator may have a frequency that is greater than a frequency of the digital micromirror device, e.g., as discussed in relation to FIGS. 1, 3, and 8. In some implementations, the polarization state modulator is axially stationary.

The reflected light is detected with a photodetector having a pixel that detects both the encoded incident angle distribution of the light and varying polarization states of the light produced by the polarization state modulator (912). In some implementations, the photodetector may have a sampling rate that is greater than the frequency of the polarization state modulator and the frequency of the digital micromirror device. For example, as discussed in reference to FIGS. 1, 3 and 8, a photodetector, such as a photodiode, may be used to detect the reflected light.

In some implementations, the method may further include determining ellipsometric measurements for the sample at each of a plurality of incidence angles based on the reflected light detected by the photodetector, e.g., as discussed in reference to the computing system 160 illustrated in FIG. 1.

In some implementations, encoding the incident angle distribution of the light includes selecting incident angles of the light in a time domain, e.g., by selecting discrete incident angles of the light or by selecting combinations of incident angles of the light, e.g., as discussed in reference to FIGS. 1, 3, 4A-4D, 5A and 5B. The means for encoding, e.g., the DMD 120 or rotating disk 124, for example, may select incident angles of the light in a time domain, e.g., by selecting discrete incident angles of the light or by selecting combinations of incident angles of the light. For example, the means for encoding may sequentially activate elements, e.g., mirror elements or holes, to select discrete incident angles of the light, e.g., as discussed in reference to FIGS. 1, 3, 4A-4D, 5A, and 5B. In some implementations, the means for encoding may select incident angles of the light in a time domain by sequentially activating elements, e.g., mirror elements or holes, to select combinations of incident angles of the light, e.g., as discussed in reference to FIGS. 1, 3, 6A-6D, 7A, and 7B. For example, the combinations of incident angles of the light may be selected based on a Hadamard matrix, as discussed in reference to FIGS. 6A-6D and 7A-7B.

In some implementations, encoding the incident angle distribution of the light includes selecting incident angles of the light in a frequency domain, e.g., as discussed in reference to FIGS. 1 and 8. The means for encoding, e.g., the DMD 120 or rotating disk 124, for example, may select incident angles of the light in a frequency domain. For example, the means for encoding may activate elements, e.g., mirror elements or holes, to frequency modulate a plurality of incident angle distributions of the light simultaneously, wherein the light is incident on the sample with the plurality of incident angle distributions simultaneously, e.g., as discussed in reference to FIGS. 1 and 8. When operating in the frequency domain, the method may further include frequency demodulating the reflected light detected by the photodetector, e.g., with a lock-in amplifier or a processor, to detect each of the plurality of incident angle distributions of the light, as discussed in reference to FIGS. 1 and 8.

The above description is intended to be illustrative, and not restrictive. For example, the above-described examples (or one or more aspects thereof) may be used in combination with each other. Other implementations can be used, such as by one of ordinary skill in the art upon reviewing the above description. Also, various features may be grouped together and less than all features of a particular disclosed implementation may be used. Thus, the following aspects are hereby incorporated into the above description as examples or implementations, with each aspect standing on its own as a separate implementation, and it is contemplated that such implementations can be combined with each other in various combinations or permutations. Therefore, the spirit and scope of the appended claims should not be limited to the foregoing description.

What is claimed is:

1. A method for performing variable angle ellipsometry, comprising:
generating light from a light source;
encoding an incident angle distribution of the light;
polarizing the light with a polarization state generator;
focusing the light on a sample with an objective lens with the incident angle distribution along an optical axis that is at an oblique angle of incidence;
analyzing reflected light from the sample with a polarization state analyzer, wherein at least one of the polarization state generator and polarization state analyzer include a polarization state modulator to vary a polarization state of the light; and
detecting the reflected light with a photodetector having a pixel that detects both the encoded incident angle distribution of the light and varying polarization states of the light produced by the polarization state modulator.

2. The method of claim 1, wherein the incident angle distribution is encoded with one of a digital micromirror device or a rotating disk located before the sample and that encodes the incident angle distribution of the light before the light is incident on the sample.

3. The method of claim 1, wherein the incident angle distribution is encoded with one of a digital micromirror device or a rotating disk located after the sample and that encodes the incident angle distribution of the light after the light is reflected from the sample.

4. The method of claim 1, further comprising determining ellipsometric measurements for the sample at each of a plurality of incidence angles based on the reflected light detected by the photodetector.

5. The method of claim 1, wherein the polarization state modulator is axially stationary.

6. The method of claim 1, wherein the objective lens has a numerical aperture (NA) with a half-angle of at least 5 degrees.

7. The method of claim 1, wherein encoding the incident angle distribution of the light comprises selecting incident angles of the light in a time domain.

8. The method of claim 7, wherein selecting incident angles of the light comprises selecting discrete incident angles of the light.

9. The method of claim 7, wherein selecting incident angles of the light comprises selecting combinations of incident angles of the light.

10. The method of claim 9, wherein the combinations of incident angles of the light are selected based on a Hadamard matrix.

11. The method of claim 1, wherein encoding the incident angle distribution of the light comprises selecting incident angles of the light in a frequency domain.

12. The method of claim 11, wherein selecting incident angles of the light comprises frequency modulating a plurality of incident angle distributions of the light simultaneously, wherein the light is incident on the sample with the plurality of incident angle distributions simultaneously.

13. The method of claim 12, further comprising frequency demodulating the reflected light detected by the photodetector to detect each of the plurality of incident angle distributions of the light.

14. A metrology device configured for variable angle ellipsometry, comprising:
a light source that generates light;
a means for encoding an incident angle distribution of the light;
a polarization state generator that polarizes the light;
an objective lens that focuses the light on a sample with the incident angle distribution along an optical axis that is at an oblique angle of incidence;
a polarization state analyzer that analyzes reflected light from the sample, wherein at least one of the polarization state generator and polarization state analyzer include a polarization state modulator to vary the polarization state of the light; and
a photodetector having a pixel configured to receive the reflected light and detect both the encoded incident angle distribution of the light and varying polarization states of the light produced by the polarization state modulator.

15. The metrology device of claim 14, wherein the means for encoding comprises one of a digital micromirror device or a rotating disk that is located before the sample and that encodes the incident angle distribution of the light before the light is incident on the sample.

16. The metrology device of claim 14, wherein the means for encoding comprises one of a digital micromirror device or a rotating disk that is located after the sample and that encodes the incident angle distribution of the light after the light is reflected from the sample.

17. The metrology device of claim 14, further comprising at least one processor coupled to the photodetector and configured to determining ellipsometric measurements for the sample at each of a plurality of incidence angles based on the reflected light detected by the photodetector.

18. The metrology device of claim 14, wherein the polarization state modulator is axially stationary.

19. The metrology device of claim 14, wherein the objective lens has a numerical aperture (NA) with a half-angle of at least 5 degrees.

20. The metrology device of claim 14, wherein the means for encoding encodes the incident angle distribution of the light by selecting incident angles of the light in a time domain.

21. The metrology device of claim 20, wherein the means for encoding selects incident angles of the light by selecting discrete incident angles of the light.

22. The metrology device of claim 20, wherein the means for encoding selects incident angles of the light by selecting combinations of incident angles of the light.

23. The metrology device of claim 22, wherein the combinations of incident angles of the light are selected based on a Hadamard matrix.

24. The metrology device of claim 14, wherein the means for encoding encodes the incident angle distribution of the light by selecting incident angles of the light in a frequency domain.

25. The metrology device of claim 24, wherein the means for encoding frequency modulates a plurality of incident angle distributions of the light simultaneously to vary incident angles of the light in the frequency domain, wherein the light is incident on the sample with the plurality of incident angle distributions simultaneously.

26. The metrology device of claim 25, further comprising at least one of a lock-in amplifier or a processor coupled to the photodetector and configured to frequency demodulate the reflected light detected by the photodetector to detect each of the plurality of incident angle distributions of the light.
